(19) United States
(12) Patent Application Publication
(10) Pub. No.: US 2013/0114168 A1
(43) Pub. Date: May 9, 2013

(54) SURGE PROTECTION

(71) Applicant: Arne Andersson, Ljustero (SE)

(72) Inventor: Arne Andersson, Ljustero (SE)

(73) Assignee: Telefonaktiebolaget L M Ericsson (publ), Stockholm (SE)

(21) Appl. No.: 13/124,747

(22) PCT Filed: Apr. 4, 2011
(86) PCT No.: PCT/SE2011/050393

§ 371 Date: Jan. 8, 2013

Related U.S. Application Data
(60) Provisional application No. 61/330,952, filed on May 4, 2010.

(51) Int. Cl. H02H 9/04

(52) U.S. Cl. CPC H02H 9/042
USPC 361/56

(57) ABSTRACT

A victim unit (310, 410) connectable to a surge protective device (300, 400a) via an alternating current system or a direct current system, the victim unit (310) comprises at least one victim unit sensor (313a, 314a, 315) adapted to measure at least one status parameter at the victim unit (310, 410) and a controller (312) operatively connected to the at least one victim unit sensor (313a, 314a, 315). The controller (312) is capable of initiating a voltage limitation of the victim unit (310) by controlling the surge protective device (300, 400a) if one or more of the at least one status parameters indicates that the victim unit (310) has reached a critical state.

### TECHNICAL FIELD

The present invention relates generally to protection of electrical equipment in electrical systems.

### BACKGROUND

Electrical equipment is often subjected to various events, such as e.g. lightning or switching operations, that may cause damage from excessive voltages and currents, i.e. electrical surges. A so-called Surge Protective Device (SPD) is a device which is used to protect electrical equipment from effects of such events. The SPD is a component normally connected at the (Alternating Current) AC or (Direct Current) DC input power terminals of the electrical equipment protected by the SPD. A main purpose of the SPD is to prevent excessive voltages and currents from the power line to destroy the electronic system or upset its function. SPDs are, for instance, used to mitigate surges in both High Voltage and Low Voltage power systems and in various communication systems.

The SPD is usually designed as a standalone device that reacts when the voltage over its terminals becomes excessive and diverts the surge current to ground in order to protect the equipment connected downstream from the SPD. The SPD therefore may be seen as a device having a non-linear voltage-current characteristic that limits voltages exceeding normal safe system levels by a rapid increase in conducted current from a zero level. SPDs may also be referred to as voltage limiters or over voltage protectors or surge arresters.

In many applications, such as e.g. RBS (Radio Base Station) main remote applications, output power terminals as well as input power terminals can be exposed to lightning. Hence the same types of difficulties associated with the input power terminals mentioned above exist also with respect to output power terminals. In these cases, the output power terminals may also be protected by SPD/s.

The term Victim Unit (VU) will be used herein to denote any type of electrical equipment that is intended to be protected by one or more SPDs.

In FIG. 1 and FIG. 2 a block diagram of an exemplary state of the art SPD 200 and VU 210 is illustrated. The state of the art SPD 200 is here used to protect a state of the art VU 210 having input impedance 316. The voltage across the SPD 200 is determined by voltage division between the various circuit elements illustrated in the FIG. 2. A functionality of the circuit illustrated in FIG. 2 is to a high degree depending on a loading effect, on the SPD 200, of the input impedance 316 of the VU 210. If the VU 210 has low input impedance, the SPD 200 will be prevented from acting and protecting the VU 210 from electrical surges. That is, the VU 210 will clamp the surge voltage to a level where the SPD 200 cannot detect an over voltage. Consequently, the SPD 200 will not operate as intended and thus fail to protect the VU 210. Instead, the VU 210 will have to absorb the energy and potentially fail in its operation despite of the fact that the SPD 200 has been correctively installed.

One solution, which is known in the art, applied for trying to overcome the above-stated difficulty regarding the SPDs 200 failure to detect a surge has been to introduce some form of inductive element (not shown) in the circuitry between the SPD 200 and the VU 210; with the aim of raising the voltage over the SPD 200 in the event of a sudden surge current. However, it is often difficult or impractical to find an appropriate inductance value that guarantees that the SPD 200 will work properly and at the same time does not interfere negatively with a normal operation of the VU 210.

The solution of introducing inductive elements is a sub-optimal solution with regards to reliability and interference with operation of the VU 210. Introducing an inductive element also brings the drawbacks of an increased cost, an increased consumption of space and an increased power loss.

Consequently, a solution comprising reliable protection of electronic equipment is needed.

### SUMMARY

According to one aspect, an improved victim unit is provided. The victim unit is connectable to a surge protective device via an alternating current system or a direct current system. The victim unit may comprise one or more victim unit sensors which may be adapted to measure one or more status parameters at the victim unit. The victim unit may further comprise a controller which may be operatively connected to the victim unit sensor. The controller may be capable of initiating a voltage limitation of the victim unit by controlling the surge protective device. Initiation of voltage limitation is performed if one or more of the at least one status parameters indicates that the victim unit has reached a critical state.

According to another aspect, a surge protective device is provided. The surge protective device may be connectable to a victim unit via an alternating current system or a direct current system. The surge protective device may comprise a voltage limitation function which may be operatively connected to a trig controller. The trig controller may be configured to send an order signal to the voltage limitation function in order to initiating a voltage limitation of the victim unit in response to receiving an instruction from the victim unit.

According to yet another aspect, a method in a victim unit is provided. The victim unit is connected to one or more surge protective devices via an alternating current system or a direct current system of protecting the victim unit. The victim unit measures one or more status parameters of the victim unit. The victim unit initiates a voltage limitation if the measured status parameters indicate that the victim unit has reached a critical state. The voltage limitation may be performed by controlling the one or more surge protective devices to limit a voltage of the victim unit.

By using the methods and/or arrangement presented above, the victim unit may be protected in a more reliable manner by monitoring and reacting based on the internal state of the victim unit.

The above methods, system and arrangements may be configured and implemented according to different embodiments. In one example embodiment, the controller may be adapted to determine that the victim unit has reached a critical state if one or more of the measured status parameter is above a respective first threshold value.

According to another example embodiment, the controller may be further adapted to control the surge protective device via an external trig signal which may provided to the surge protective device if the status parameter is above the respective first threshold value.

In one example embodiment, the victim unit may be further connectable to one or more additional surge protective device. The controller may further be adapted to control each connected surge protective device by providing the external trig signal to each of the surge protective devices.

According to another example embodiment, the controller may further be adapted to analyze the status parameters to select the one or more surge protective devices on the basis of the analysis. The controller may further be adapted to control the selected surge protective devices via the external trig signals.

According to another example embodiment, the status parameter may comprise one or more of: an input current of the victim unit, an input voltage of the victim unit, an internal current of the victim unit and an internal voltage of the victim unit.

According to another example embodiment, a system comprising a victim unit and a surge protective device is provided. The system may also comprise a surge generator which may be connected to the victim unit and the surge protective device such that it can simulate an electrical surge event capable of triggering a voltage limitation initiation of the victim unit.

Further possible features and benefits of this solution will become apparent from the detailed description below.

### BRIEF DESCRIPTION OF DRAWINGS

The invention is now described, by way of example, with reference to the accompanying drawings, in which:

FIG. 1 illustrates a block scheme of a surge victim, a surge protective device, a surge generator and main voltage according to prior art.

FIG. 2 shows the surge victim and surge protective device of FIG. 1, according to prior art.

FIG. 3 shows one embodiment of a surge victim comprising means for triggering an externally triggered surge protective device, according to one example embodiment.

FIG. 4 shows an alternative embodiment having several input and/or output terminals and several SPDs, according to'one example embodiment.

FIG. 5 shows an exemplary block scheme illustrating a surge generator in connection with a SPD and a VU, according to one example embodiment.

FIG. 6 is a flow chart illustrating the steps of Performing an improved surge protection, according to one example embodiment.

FIG. 7 is a flow chart illustrating the method for performing an improved surge protection comprising optional steps, according to one example embodiment.

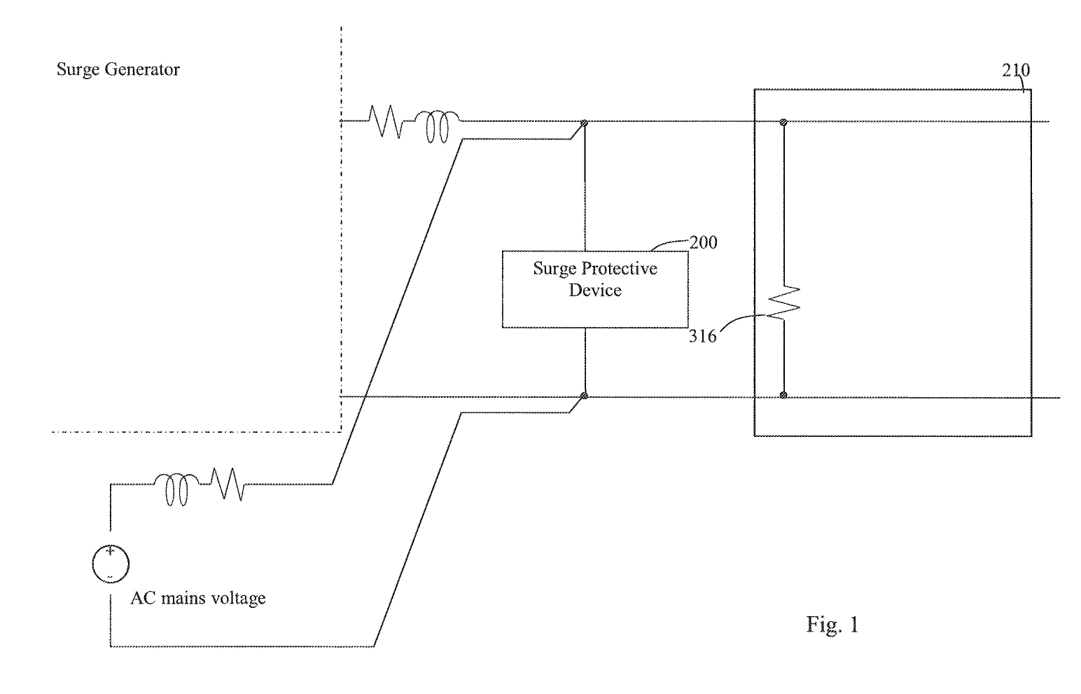

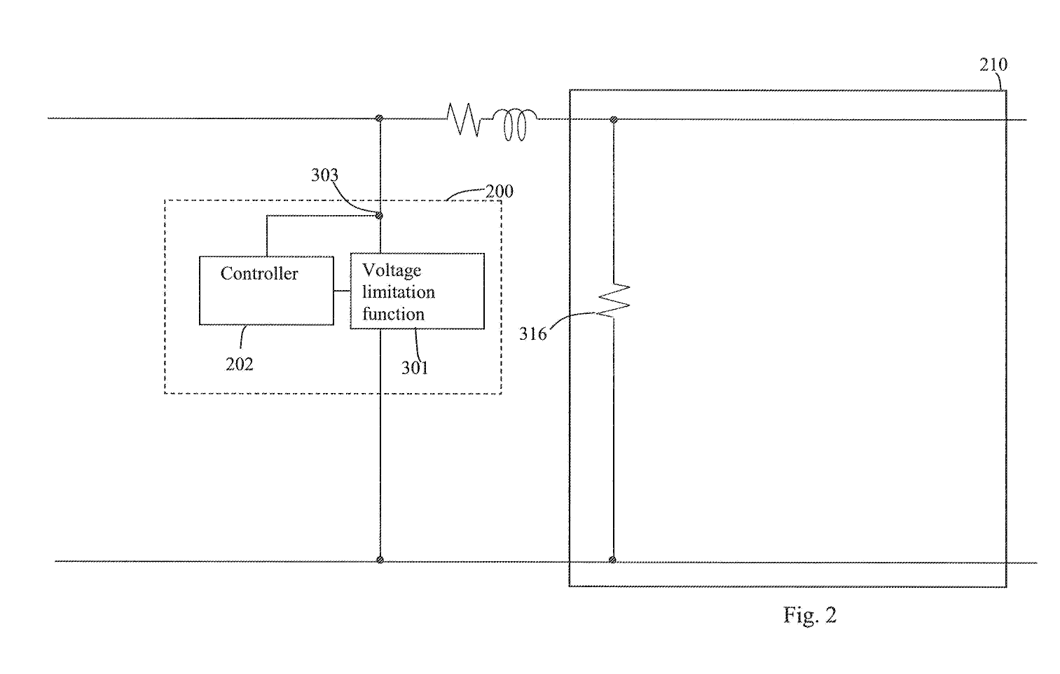

### DETAILED DESCRIPTION

In the following, a detailed description of an improved surge protection is disclosed. Instead of only having one or several SPDs measuring and reacting to an electrical surge measured by a voltage sensor, the solution discloses a Victim Unit (VU) comprising an internal supervision system enabled to measure and supervise the state of the VU. In this description, the term “VU” is used to describe any type of electronic equipment connected to a power source and where the VU and/or the source may be exposed to excessive voltages and currents, i.e. electrical surges.

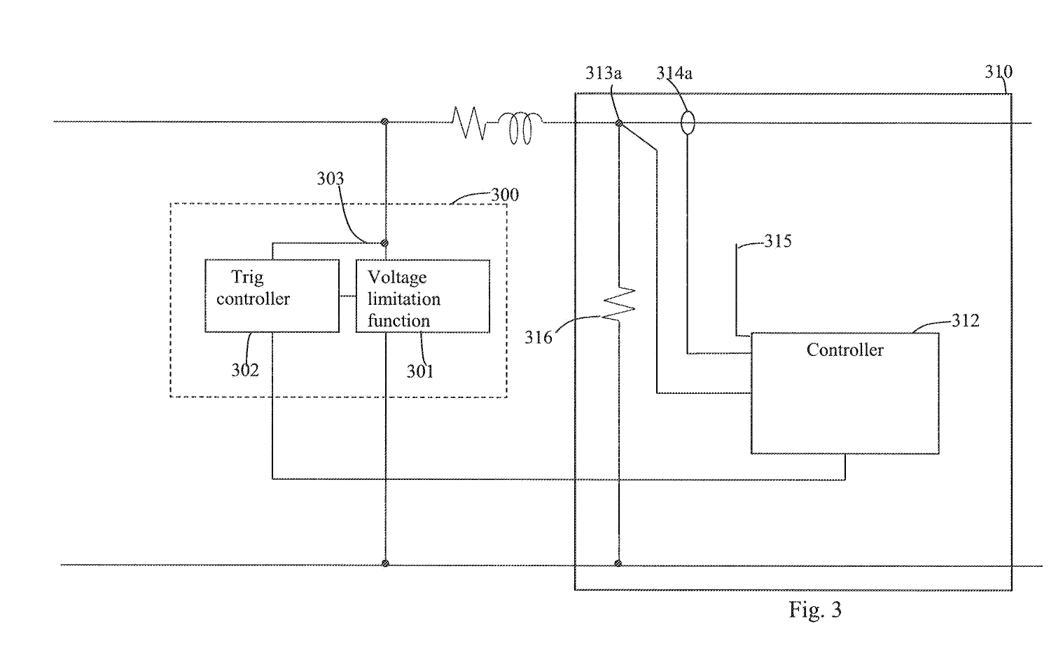

FIG. 3 shows a block diagram of one example embodiment of a power distribution system comprising a SPD 300 and a VU 310. In this embodiment, the SPD 300 is arranged externally to the VU 310. It is to be understood by the person skilled in the art that this arrangement can be a DC system, a single phase or a polyphase AC system. In the embodiment disclosed in FIG. 3, the VU 310 is provided with the three sensors 313a, 314a and 315, each of which may be referred to as VU sensors and which are capable of measuring at least one status parameter representing an internal status of the VU 310. The status parameter/s may e.g. comprise an input voltage, an input current, an internal voltage, an internal current, or any combination thereof. However the status parameter/s can alternatively comprise other status parameters indicating the state and/or the functionality of the VU 310. In this particular embodiment the VU 310 comprises one sensor 313a for measuring input voltage, another sensor 314a adapted for measuring input current and yet another sensor 315 adapted for measuring other status parameters such as, e.g. internal voltage/s and/or internal current/s. However, the sensors 313a, 314a, 315 may be arranged in other ways which will become apparent to the person skilled in the art. The VU 310 supervises the status parameter/s provided by the sensors 313a, 314a, 315 and determines whether or not a critical state of the VU 310 has been reached. I.e. if a measured status parameter is above a first associated threshold value the VU 310 may be at risk of malfunctioning.

The VU 310 may e.g. be any type of electronic equipment connected to an AC or DC power line. For example, in a RBS, the VU 310 could typically be the AC Power supplies converting AC mains power to DC power used within the RBS.

The VU 310 further comprises a controller 312 which is operatively connected to the sensors 313a, 314a, 315 of the VU 310. The controller 312 is capable of generating a first trigger signal, from herein after further denoted as an external trig signal, to one or a plurality of SPDs 300, such that the one or more SPDs can be triggered from the VU 310. The controller generates an external trig signal based on the status parameter/s which is/are measured by one or more of the sensors 313a, 314a, 315. Based on the one or more status parameters measured by one or more of the VU sensors 313a, 314a, 315 the controller 312 can determine whether or not the VU 310 has reached a critical state. In such scenario the controller 312 is configured to generate and send an external trig signal to the SPD 300 to trigger a voltage limitation function 301 which is arranged in connection to the input power of the VU 310. The VU 310 will consequently, by sending an external trig signal, turn on one or several SPDs voltage limitation functions and clamp the surge so as to protect the VU 310.

The person skilled in the art will appreciate that the controller 312 may be implemented using standard circuit technologies, which exists in profusion. The controller 312 may be implemented using discrete electrical components, using one or more application specific integrated circuits, using programmable circuitry or using any combination thereof. The controller may alternatively be implemented completely or in part using one or more processors programmed with suitable software.

The external trig signal/s which is sent by the controller 312 to one or more SPDs may be distributed as an electronic signal or by optical transmission, e.g. such as opto-coupler and/or optical fiber. However, the external trig signal can also be transmitted by other means known to the person skilled in the art.

The SPD 300 comprises a voltage limitation function 301 capable of limiting the input voltage to the VU 310. The SPD 300 further comprises a trig controller 302 operatively connected to the voltage limitation function 301. The trig controller 302 is adapted to instruct the voltage limitation function 301 to limit the input voltage and thus limiting the surge current into the victim 310 if the trigger controller 302 receives an external trig signal which is typically generated by the VU 310, or an internal SPD trig signal which is typically generated by a voltage sensor 303.

The voltage limitation function 301 is adapted to, in response to an instruction from the trig controller 302, initiate a voltage limitation in the SPD 300 by opening up a current flow through the SPD 300 to ground, so as to limit the voltage over the SPD and protect the VU 310 from voltages and current surges.

The voltage sensor 303, which is an optional sensor, is capable of measuring the input voltage to the SPD 300. If the voltage sensor 303 measures an input voltage above a second threshold value the trig controller 302 instructs the voltage limitation function 301 to limit the voltage. Hence, the SPD 300 is not solely dependent on external triggering in order to divert and arrest a surge current.

The voltage limitation function 301 may be implemented using conventional technologies allowing for a triggered voltage limitation. For example, the voltage limitation function could, depending on the application, be implemented using triggered Spark Gap (SG) technology or triggered Gas Discharge Tube (GDT) technology. However, other ways of implementing triggered voltage limitation functions using conventional technologies will be apparent to the person skilled in the art.

The SPD 300 may retain its normal function in combination with a capability of activation by an external trig signal. The SPD 300 can therefore be controlled by the VU 310. The VU 310 may consequently trigger a voltage limitation function 301 in the SPD 300 even in a situation where the voltage sensor 303 does not detect an over voltage condition, possibly due to loading effects caused by a low input impedance of the VU 310. The present invention therefore allows the VU 310 to supervise its internal status and when needed, provide an external trig signal enabling one or several SPDs' voltage limitation function 301 in order to remove a threat to the VU 310, regardless of voltage division effects associated with the various impedances in the circuit. The use inductive elements, and its associated drawbacks, can therefore be avoided.

The person skilled in the art will appreciate that the trig controller 302, as well as any additional controller, may be implemented using standard circuit technologies, which exists in profusion. For example, the trig controller 302 may be implemented using discrete electrical components, using one or more application specific integrated circuits, using programmable circuitry or using any combination thereof. The trig controller 302 may also be implemented completely or in part using one or more processors programmed with suitable software.

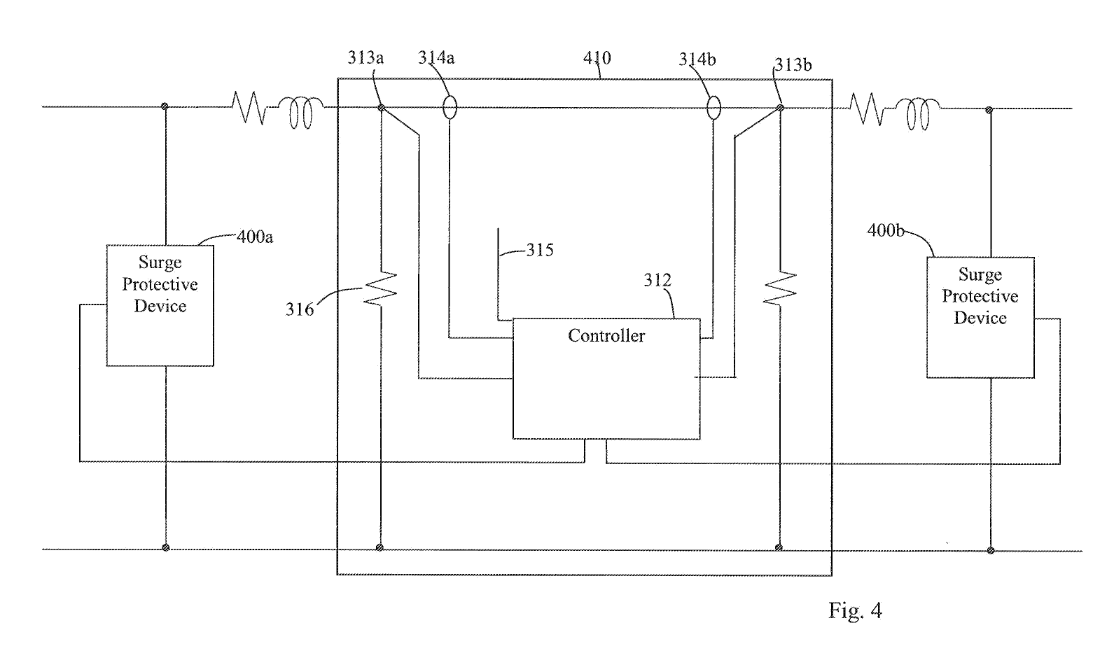

With reference to FIG. 4 will now a VU 410 which is connected to input power terminals and output terminals be described. It is to be understood that although the arrangement of FIG. 3 only comprises one SPD 300, the VU 410 may alternatively be arranged to control two or more SPDs 400a, 400b. A first SPD 400a is arranged to be connected to the input power terminal and a second SPD 400b is arranged to be connected to the output power terminal, In this specific embodiment the status parameter/s are assumed to be the input current and the input voltage associated with each corresponding power terminal. Naturally, the status parameter/s could also comprise other status parameters as above-disclosed in this document.

If the controller 312 of the VU 410 during supervision of the status parameters detects that the input current and/or the input voltage at the input power terminal is an over current or an electric surge the controller 312 sends an external trig signal to the first SPD 400a which is connected to the input power terminal.

Similarly, if, during supervision of the status parameters, the controller 312 of the VU 410 detects that the input current and/or the input voltage at one of the output power terminal pairs is an over current or an electric surge the controller 312 sends an external trig signal to the second SPD 400b which is connected to the output power terminal.

In one embodiment, all of the connected SPDs 400a, 400b may be triggered as a reaction to an over current or an electric surge. However, in the embodiment according to FIG. 4 normally only one SPD is triggered at a time based on the status parameters of each power terminal, i.e. the input power terminal or the output power terminal.

As already disclosed above and further illustrated in FIG. 4, the VU 410 can comprise a plurality of power terminals and consequently also employ a plurality of SPDs 400a, 400b for protection of each power terminal. If the controller 312 which is arranged in the VU 410 determines that the VU 410 has reached a critical state, the controller 312 may in this alternative embodiment be configured to first analyze the particulars of the status parameter, e.g. such as the input power terminal or output power terminal associated with the status parameter/s indicating the critical state.

Based on the result of the analysis, the controller 312 is configured to select and trigger one or a plurality of SPDs 400a, 400b by generating at least one trig signal accordingly. Even if this exemplary embodiment comprises two SPDs it should be apparent to the person skilled in the art that any number of SPDs can be employed. In particular at least one SPD arranged in connection to each of the VUs input power terminal/s and/or each of the VUs output power terminals.

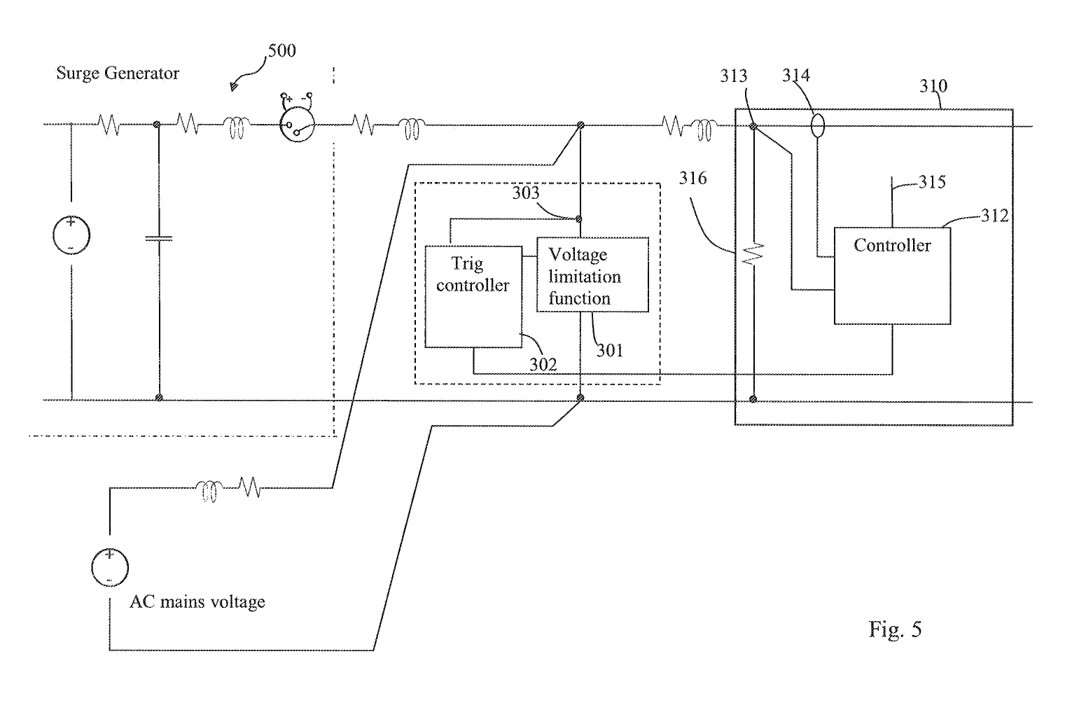

According to another optional and exemplary embodiment, which is illustrated in FIG. 5, a surge generator 500 may be provided in connection to one or more SPDs 300 and a VU 310. The purpose of the surge generator 500 is to simulate an electrical surge in order to investigate the downstream equipments' capability to withstand an electrical surge. A surge generator 500 according to FIG. 5 can thus be used as means for diagnosis of the SPD 300 and the VU 310. It should be noted that the design of the surge generator 500 is purely exemplary, and that other configurations known in the art may alternatively be used. It should further be understood that, even if this example is made with only one SPD and one input terminal, a surge generator 500 can be used and connected accordingly with any number of input and/or output power terminals and any number of SPDs.

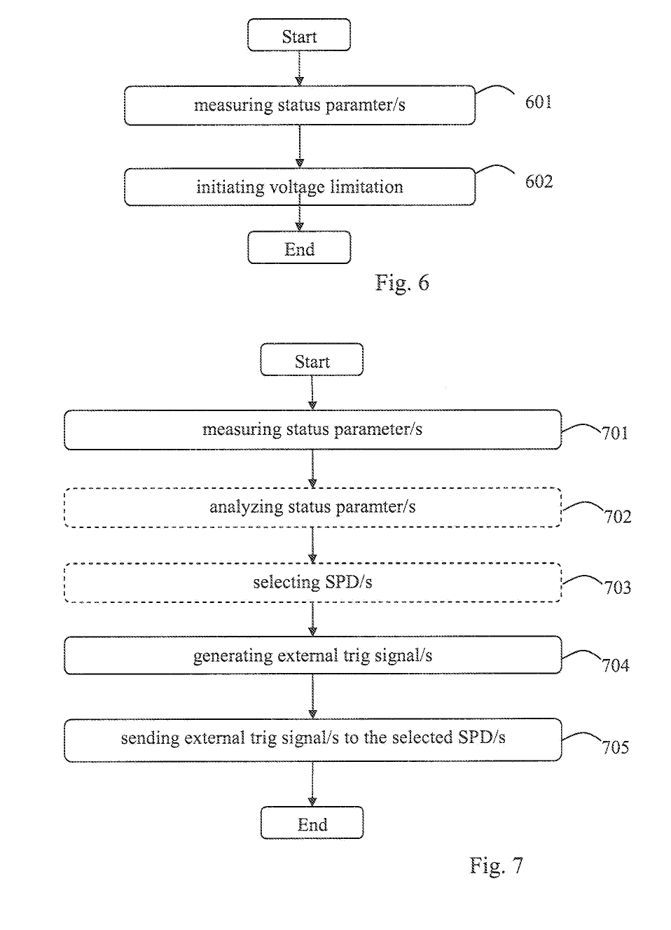

Now referring to FIG. 6 which illustrates a flow-chart describing a procedure for enabling protection of a VU described in FIGS. 3-5, according to one example embodiment. The method comprises an action 601 of measuring at least one status parameter, which represents the internal status of the VU. The at least one status parameter may comprise a parameter measured on the input power terminal of the VU or on the output power terminal of the VU, such as e.g. an input voltage and/or an input current, or a parameter measured within the VU, such as e.g. an internal voltage and/or an internal current. However, other parameters indicating the status of the VU could also be used as status parameter/s for the controller.

The VU may be connected to one or more surge protective devices on order to limit the voltage of the VU if necessary. Thus, in action 602, the VU initiates a voltage limitation if the measured status parameter/s indicates that that the VU has reached a critical state. Then, the controller may-control the voltage limitation by instructing one or more surge protective devices to limit the voltage of the VU.

FIG. 7 shows a flow chart illustrating an alternative example embodiment of a procedure for protecting a VU. Similarly to the procedure shown with reference to FIG. 6 above, the status of the VU is measured in action 701. The procedure further comprises an optional action 702 of analyzing the at least one measured status parameter/s. The procedure further may comprise the optional action 703 comprising selecting, based on the result from the action 702, at least one SPD. In action 704 a trig signal is generated which is sent, in action 705, to the selected SPDs, and thereby enabling the surge current to be diverted over the SPD instead of potentially disturb the VU. In this particular embodiment the VU comprises several input power terminals or output terminals. Thus, the VU may be capable of enabling one or a plurality of SPDs connected to the surge current to divert the surge current, based on the analysis of action 703.

Modifications and other embodiments of the disclosed invention will come to mind to one skilled in the art having the benefit of the teachings presented in the foregoing descriptions and the associated drawings. Therefore, it is to be understood that the invention is not to be limited to the specific embodiments disclosed and that modifications and other embodiments are intended to be included within the scope of this document. Although specific terms may be employed herein, they are used in a generic and descriptive sense only and not for purposes of limitation.

### Abbreviations

AC—Alternating Current
DC—Direct Current
RBS—Radio Base Station
SG—Spark Gap
GDT—Gas Discharge Tube
SPD—Surge Protective Device
VU—Victim Unit

1. A victim unit connectable to a surge protective device via an alternating current system or a direct current system, the victim unit comprising:
at least one victim unit sensor adapted to measure at least one status parameter at said victim unit and a controller operatively connected to said at least one victim unit sensor, wherein said controller is capable of initiating a voltage limitation of said victim unit by controlling said surge protective device if one or more of said at least one status parameters indicates that said victim unit has reached a critical state.

2. A victim unit according to claim 1, wherein said controller is adapted to determine that said victim unit has reached a critical state if one or more of said at least one measured status parameter is above a respective first threshold value.

3. A victim unit according to claim 2, wherein said controller is further adapted to control said surge protective device via an external trig signal provided to said surge protective device if said at least one status parameter is above said respective first threshold value.

4. A victim unit according to claim 3, wherein the victim unit is further connectable to at least one additional surge protective device, wherein said controller is further adapted to control each connected surge protective device by providing said external trig signal to each of said surge protective devices.

5. A victim unit according to claim 3, wherein said controller is further adapted to analyze said one or more status parameters; to select at least one of said surge protective devices on the basis of said analysis, and to control the selected surge protective device/s via said external trig signals.

6. A victim unit according to claim 1, wherein said status parameter comprise at least one of: an input current of the victim unit, an input voltage of the victim unit, an internal current of the victim unit and an internal voltage of the victim unit.

7. A surge protective device connectable to a victim unit via an alternating current system or a direct current system, the surge protective device comprising:
a voltage limitation function operatively connected-to a trig controller wherein said trig controller is configured to send an order signal to said voltage limitation function to initiate a voltage limitation of said victim unit in response to receiving an instruction from said victim unit.

8. A surge protective device according to claim 7, further comprising:
a voltage sensor operatively connected to said trig controller wherein said trig controller is configured to instruct the voltage limitation function to initiate a voltage limitation of said victim unit if a voltage measured by said voltage sensor is above a second threshold value.

9. A surge protective device according to claim 7, wherein the voltage limitation function is adapted to initiate a voltage limitation by opening up a current flow through a respective triggered surge protective device.

10. A surge protective device according to claim 7, wherein said instruction from said victim unit is an external trig signal provided by a controller in said victim unit.

11. A system comprising a victim unit according to claim 1 and a surge generator, wherein said surge generator is connected to the victim unit and said surge protective device such that it can simulate an electrical surge event capable of triggering a voltage limitation initiation of said victim unit.

12. A method at a victim unit connected to at least one surge protective device via an alternating current system or a direct current system of protecting said victim unit, said method comprising:
measuring at least one status parameter of the victim unit;
initiating voltage limitation of said victim unit, if said measuring indicates that said victim unit has reached a critical state, wherein said voltage limitation is performed by controlling at least one surge protective device to limit a voltage of said victim unit.

13. A method according to claim 13, wherein said victim unit is considered to have reached a critical state if, during said measuring, at least one status parameter is above an first threshold value.

14. A method according to claim 12, wherein said surge protective device is controlled via an external trig signal which is provided to said surge protective device if said victim unit has reached a critical state.

15. A method according to claim 14, wherein said initiating voltage limitation of said victim unit further comprises to sending said external trig signal to each of said at least one surge protective device to limit the voltage of said victim unit.

16. A method according to claim 14, further comprising:
analyzing said at least one status parameter; and
selecting, based on the result from said step of analyzing, at least one surge protective device; and
sending said external trig signal to said selected at least one surge protective device/es, thereby enabling said selected at least one surge protective device to limit a voltage of said victim unit.

17. A method according to claim 12, wherein said at least one status parameter comprises at least one of: an input current of the victim unit, an input voltage of the victim unit, an internal current of the victim unit and an internal voltage of the victim unit.
